(19) United States
(12) Patent Application Publication
(10) Pub. No.: US 2013/0341170 A1
(43) Pub. Date: Dec. 26, 2013

(54) KEY MEMBRANE AND ELECTRONIC DEVICE USING THE SAME

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: YONG-JUN YU, Shenzhen (CN); XUE-FENG WAN, Shenzhen (CN); FAN YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/726,258

(22) Filed: Dec. 24, 2012

(30) Foreign Application Priority Data
Jun. 20, 2012 (CN) 2012102046424

(51) Int. Cl. H01H 13/704

(52) U.S. Cl. CPC H01H 13/704
USPC 200/5 A

(57) ABSTRACT

An electronic device comprises a housing, a printed circuit board (PCB) received in the housing, and a key membrane covered on the PCB. The housing comprises a key portion with a plurality of keys. The key membrane comprises a first insulating layer and a second insulating layer covered by the first insulating layer. The second insulating layer is mounted on the PCB and defines a plurality of through holes. The through holes correspond to the plurality of keys in a one-to-one relationship. When one of the plurality of keys is being pressed, a part of the first insulating layer corresponding to the pressed key is deformed and establishes the electrical connection with the PCB, thus the PCB is actuated to generate a corresponding control signal.

### BACKGROUND

1. Technical Field

The present disclosure relates to electronic devices, and more particularly relates to an electronic device with a key membrane.

2. Description of Related Art

Electronic devices, such as DVD players, include a key portion with a plurality of keys, a printed circuit board (PCB), and a key membrane set between the key portion and the PCB. The key membrane is a single insulating membrane and includes a plurality of conductive portions corresponding to the keys. The single insulating membrane covers on the PCB. The conductive portions are pasted on the surface of the single insulating membrane facing the PCB. However, when the single insulating membrane becomes thinner, the touching sensation of the electronic device improves, but the pasting operation of the conductive portion becomes more difficult; when the single insulating membrane becomes thicker, the touching sensation of the key is reduced, but the pasting operation of the conductive portion improves. Thus, the single insulating membrane cannot synchronously improve the pasting operation and the touching sensation.

Therefore, there is room for improvement in the art.

### BRIEF DESCRIPTION OF THE FIGURE

The components of the drawings are not necessarily drawn to scale, the emphasis instead being placed upon clearly illustrating the principles of the embodiment of an electronic device. Moreover, in the drawings, like reference numerals designate corresponding parts throughout several views.

FIG. 1 is a schematic view of an electronic device, according to an embodiment.

FIG. 2 is a partially disassembled view of the electronic device of FIG. 1.

FIG. 3 is a cross-section view taken along a line III-III of FIG. 1.

FIG. 4 is a partially enlarged view of section IV of FIG. 3.

### DETAILED DESCRIPTION

Embodiments of the present disclosure will be described in detail with reference to the drawings.

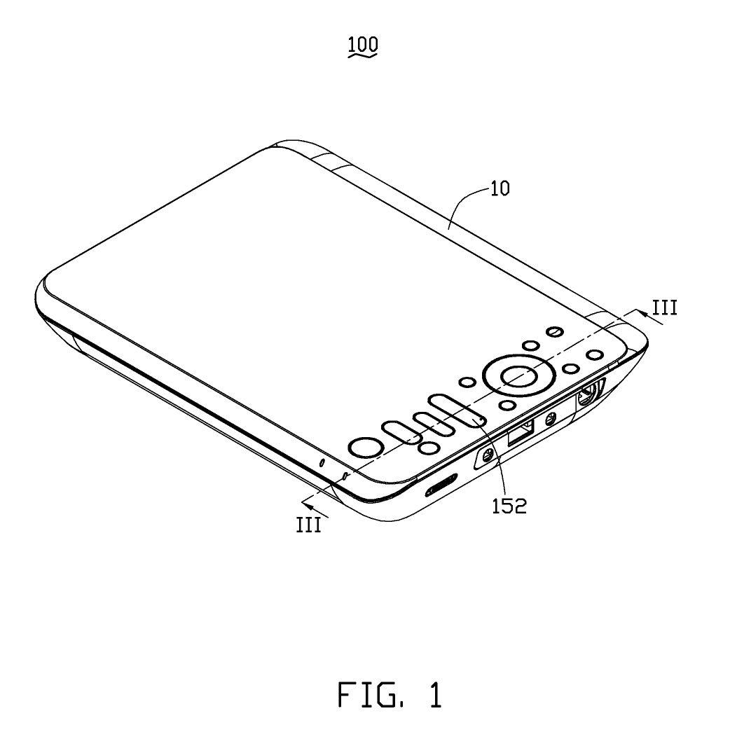

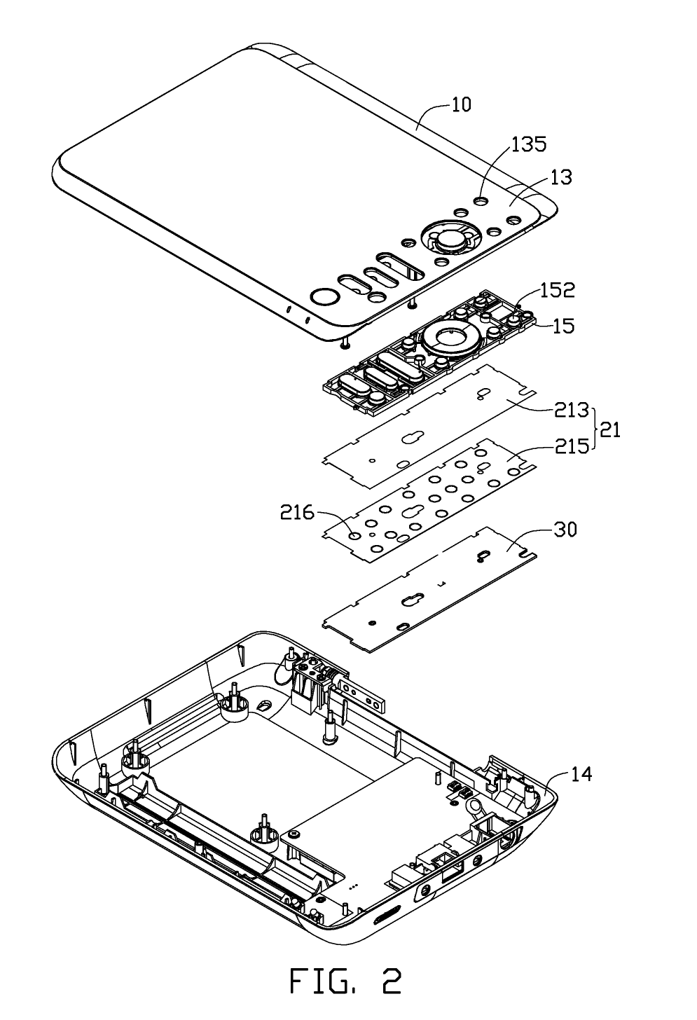

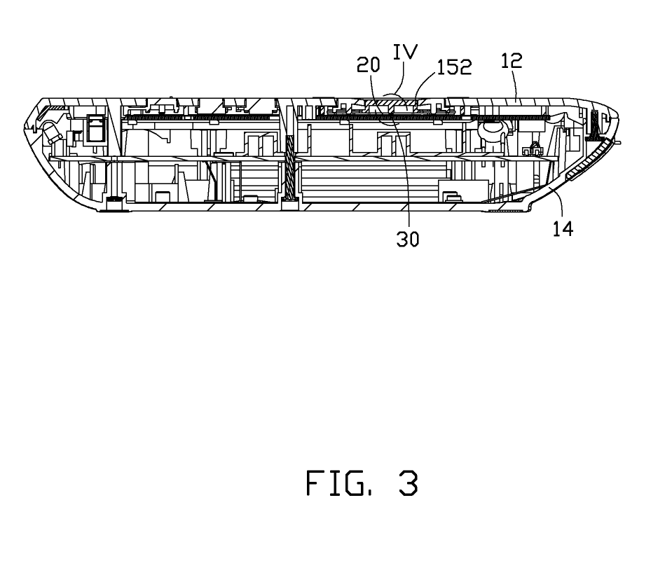

FIGS. 1 and 2 show an electronic device 100 of the embodiment. The electronic device 100 includes a housing 10, a key membrane 20 (as shown in FIG. 3), and a printed circuit board (PCB) 30. The key membrane 20 covers the PCB 30, and is used for establishing an electrical connection with the PCB 30. The key membrane 20 is deformable when being pressed, and the PCB 30 generates a corresponding control signal when the key membrane 20 is deformed. In the embodiment, the electronic device 100 is a portable DVD player.

The housing 10 includes an upper cover 12 (as shown in FIG. 3), a bottom cover 14. The upper cover 12 cooperates with the bottom cover 14 to form a closed space (not labeled) for receiving the key membrane 20, the PCB 30, and other electronic components (not shown), such as an optical reading head. The upper cover 12 is substantially rectangular and includes a key setting portion 13 and a key portion 15 mounted to the key setting portion 13. The key setting portion 13 defines a plurality of openings 135. In the embodiment, the shape of the openings 135 may be the same or different, such as rectangular or circular.

The key portion 15 includes a plurality of keys 152. The keys 152 are corresponding to the openings 135 in a one-to-one relationship and are exposed from the electronic device 100 through the corresponding openings 135. In other embodiments, the keys 152 can be integrally formed with the upper cover 12.

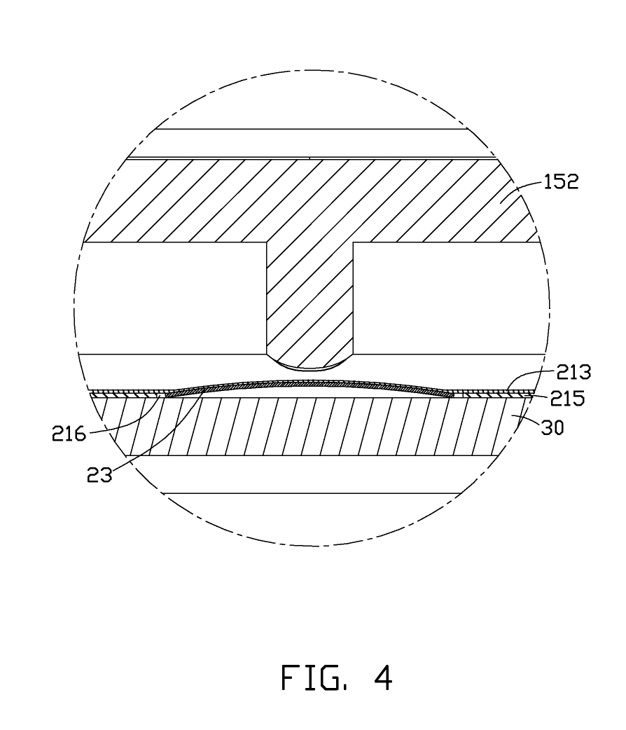

FIGS. 3 and 4 show the key membrane 20 of the embodiment. The key membrane 20 is set between the key portion 15 and the PCB 30. The key membrane 20 includes a double insulating membrane 21 and a plurality of conductive portions 23 (see FIG. 4). The double insulating membrane 21 includes a first insulating layer 213 and a second insulating layer 215. The first insulating layer 213 completely covered on the second insulating layer 215 and can be partly deformed by the pressed key 152. The thickness of the first insulating layer 213 is less than that of the second insulating layer 215. In the embodiment, the first insulating layer 213 is substantially rectangular. In the other embodiments, the first insulating layer 213 can be a circle or polygonal shaped. The second insulating layer 215 defines a plurality of through holes 216. The through hole 216 is corresponding to the conductive portions 23 in a one-to-one relationship. In the embodiment, the thickness of the first insulating layer 213 is 0.05 mm and the thickness of the second insulating layer 215 is 0.1 mm.

The conductive portions 23 correspond to the keys 152 in a one-to-one relationship. Each conductive portion 23 can be elastically deformed by the corresponding pressed key and establish an electrical connection with the PCB 30. Each the conductive portion 23 is substantially hollow cap-shaped. The top of the conductive portion 23 is pasted on the first insulating layer 213 through the corresponding through hole 216, and faces a conductive position of the PCB 30. The bottom edge of the conductive portion 23 is connected to an insulating position of the PCB 30. The diameter of the conductive portion 23 is less than that of the through hole 216. The height of the conductive portion 23 is larger than the sum thickness of the first insulating layer 213 and the second insulating layer 215. In the embodiment, when viewed from the upper surface of the insulating layer 213, the conductive portion 23 protrudes outwardly from the first insulating layer 213; when viewed from the lower surface of the first insulating layer 213, the conductive portion 23 is recessed in a bottom surface of the insulating layer 213.

The PCB 30 is substantially rectangular and is used for generating a control signal for controlling the electronic device 100 to execute a corresponding function when the conductive portion 23 establishes the electrical connection with the PCB 30, such as a playing music or playing a video, for example.

After being assembled, the second insulating layer 215 is covering on the PCB 30. Each conductive portion 23 is pasted on the first insulating layer 213 through the through hole 216. When the first insulating layer 213 is covered on the second insulating layer 215, the conductive portion 23 abuts the insulating position of PCB 30 through the corresponding through hole 216 and is spaced from the through hole 216 to define a deformed space. Because the height of the conductive portion 23 is larger than the sum thickness of the first insulating layer 213 and the second insulating layer 215, the part of the first insulating layer 213 corresponding to the conductive portion 23 bulges along the shape of the conductive portion 23. When any of the keys 152 is being pressed, the first insulating layer 213 and the conductive portion 23 are deformed; the deformed conductive portion 23 is electrically connected with the conductive position of the PCB 30 and establishes an electrical connection therewith. The PCB 30 generates the corresponding control signal for controlling the electronic device 100 to execute a function. When the pressed key 152 is released, the conductive portion 23 is resumed and provides elastic force to restore the pressed key 152 to the original position.

As described, using the key membrane with the double layers structure, only one layer of the key membrane is set between the key and the corresponding conductive portion. Therefore, the pasting operation and the touching sensation are synchronously improved.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. An electronic device, comprising:
a plurality of keys mounted in a housing;
a PCB received in the housing; and
a key membrane arranged between the keys and the PCB and adapted to be partly deform and establish an electrical connection with the PCB when being pressed by the plurality of keys;
wherein the key membrane comprises a first insulating layer and a second insulating layer covered by the first insulating layer; the second insulating layer is mounted on the PCB and defines a plurality of through holes; the through holes correspond to the plurality of keys in a one-to-one relationship; when one of the plurality of keys is being pressed, the first insulating layer corresponding to the pressed key is deformed to establish the electrical connection with the PCB, thus the PCB is actuated to generate a corresponding control signal.

2. The electronic device of claim 1, wherein the thickness of the first insulating layer is less than the second insulating layer.

3. The electronic device of claim 2, wherein the thickness of the first insulating layer is 0.05 mm; the thickness of the second insulating layer is 0.1 mm.

4. The electronic device of claim 1, wherein the key membrane further comprises a plurality of conductive portions mounted on the surface; the conductive portions correspond to the plurality of keys in a one-to-one relationship and connected with an insulating position of the PCB through the corresponding through hole; when one of the plurality of keys is being pressed, the conductive portion is deformed and establishes an electrical connection with a conductive position of the PCB for actuating the PCB to generate a corresponding control signal.

5. The electronic device of claim 4, wherein the height of the conductive portion is larger than the sum thickness of the first insulating layer and the second insulating layer.

6. The electronic device of claim 4, wherein the conductive portion is a hollow cap-shaped, the diameter of the conductive is less than the diameter of the corresponding through hole.

7. An electronic device, comprising:
a plurality of keys mounted in a housing;
a PCB received in the housing and capable of generating different control signals when pressed by the plurality of keys; and
a key membrane arranged between the plurality of keys and the PCB, and deformed by a pressed key to establish an electrical connection with the PCB for actuating the PCB to generate a corresponding control signal;
wherein the thickness of a part of the key membrane which can be deformed by the pressed key is less than that of other part of the key membrane.

8. The electronic device of claim 7, wherein the key membrane comprises a first insulating layer and a second insulating layer covered on the PCB; the first insulating layer is covered on the second insulating layer and can be partly deformed; the second insulating layer defines a plurality of through holes corresponding to the plurality of keys in a one-to-one relationship; when one of the plurality of keys is pressed, the first insulating layer is partly deformed and connected to the PCB through the corresponding through hole.

9. The electronic device of claim 8, wherein the thickness of the first insulating layer is less than the second insulating layer.

10. The electronic device of claim 9, wherein the thickness of the first insulating layer is 0.05 mm; the thickness of the second insulating layer is 0.1 mm.

11. The electronic device of claim 8, wherein the key membrane further comprises a plurality of conductive portions mounted on the surface of the first insulating layer; the conductive portions are corresponding to the through holes in a one-to-one relationship and are connected to an insulating position of the PCB through the corresponding through hole, when one of the plurality of keys is pressed, the conductive portion is deformed and establishes an electrical connection with a conductive position of the PCB to actuate the PCB to generate a corresponding control signal.

12. A key membrane arranged between a plurality of keys and a PCB, comprising:
a first insulating layer capable of being partly deformed; and
a second insulating layer mounted on the PCB and being covered by the first insulating layer;
wherein the second insulating layer defines a plurality of through holes corresponding to the plurality of keys in a one-to-one relationship; when one of the plurality of keys is pressed, a part of the first insulating layer corresponding to the pressed key is deformed to establish an electrical connection with the PCB for actuating the PCB to generate a corresponding control signal.

13. The key membrane of claim 12, wherein the thickness of the first insulating layer is less than the second insulating layer.

14. The key membrane of claim 12, wherein the thickness of the first insulating layer is 0.05 mm; the thickness of the second insulating layer is 0.1 mm.

15. The key membrane of claim 11, wherein the key membrane further comprises a plurality of conductive portions mounted on the surface of the first insulating layer; the conductive portions correspond to the through holes in a one-to-one relationship and connected with an insulating position of the PCB; the conductive portion is deformed by the deformed first insulating layer and establishes an electrical connection with a conductive position of the PCB.

16. The key membrane of claim 15, wherein the height of the conductive portion is larger than the sum thickness of the first insulating layer and the second insulating layer.

17. The key membrane of claim 15, wherein the conductive portion is a hollow cap-shaped, the diameter of the conductive is less than the diameter of the corresponding through hole.
